(19) United States
(12) Patent Application Publication
(10) Pub. No.: US 2024/0387099 A1
(43) Pub. Date: Nov. 21, 2024

(54) WELDING TRANSFORMER

(71) Applicant: Panasonic Intellectual Property Management Co., Ltd., Osaka (JP)

(72) Inventors: Kenta TAMAGAWA, Osaka (JP); Hidetoshi OYAMA, Osaka (JP)

(21) Appl. No.: 18/789,021

(22) Filed: Jul. 30, 2024

Related U.S. Application Data
(63) Continuation of application No. PCT/JP2023/003368, filed on Feb. 2, 2023.

(30) Foreign Application Priority Data
Feb. 21, 2022 (JP) 2022-025028

(51) Int. Cl. H01F 27/32

(52) U.S. Cl. CPC H01F 27/32

(57) ABSTRACT

A copper plate that forms a primary-side unit coil has a body portion, a first terminal portion, and a second terminal portion. A first insulating sheet has a first insulating portion and a second insulating portion. The first insulating portion extends along a surface of the body portion. The second insulating portion passes through a space between the first terminal portion and the second terminal portion.

### CROSS-REFERENCE TO RELATED APPLICATIONS

This is a continuation of International Application No. PCT/JP2023/003368 filed on Feb. 2, 2023, which claims priority to Japanese Patent Application No. 2022-025028 filed on Feb. 21, 2022. The entire disclosures of these applications are incorporated by reference herein.

### BACKGROUND

The present disclosure relates to welding transformers.

Japanese Unexamined Patent Application Publication No. 2004-200458 discloses a configuration of a welding transformer having a primary winding and a secondary winding in which insulating sheets having cuts and creases are folded to wrap coils (secondary winding) made of copper plates.

### SUMMARY

In the invention of Japanese Unexamined Patent Application Publication No. 2004-200458, two terminals of the coils are extended side by side in the same direction. When dust etc. is generated in the welding work environment, the two terminals may be short-circuited due to the dust accumulating inside the insulating sheets.

The present invention was made in view of the above circumstances, and an object of the present invention is to reduce short-circuiting between terminals of coils.

According to a first aspect, a welding transformer includes a coil including a plurality of unit coils. The unit coil is composed of a stack of a plurality of unit coil components that is plate-like conductors. The unit coil component includes a body portion that extends in an annular shape, and a first terminal portion and a second terminal portion that are extended from the body portion and that extend in the same direction and spaced apart from each other. The welding transformer further includes an insulating sheet that insulates the unit coil component. The insulating sheet includes a first insulating portion that extends along a surface of the body portion, and a second insulating portion that passes through a space between the first terminal portion and the second terminal portion.

In the first aspect, the unit coil component includes the body portion, the first terminal portion, and the second terminal portion. The insulating sheet includes the first insulating portion and the second insulating portion. The first insulating portion extends along the surface of the body portion. The second insulating portion passes through the space between the first terminal portion and the second terminal portion.

With this configuration, the body portions of the stacked unit coil components can be insulated from each other by the first insulating portion, and the first terminal portion and the second terminal portion can be insulated from each other by the second insulating portion. Since part of the first insulating sheet is passed between the first terminal portion and the second terminal portion as described above, short-circuiting between the first terminal portion and the second terminal portion can be reduced even when dust etc. is generated in the welding work environment.

According to a second aspect, in the welding transformer of the first aspect, the insulating sheet includes a first insulating sheet having an annular shape along the body portion, the first insulating sheet has a cut made in a portion in a circumferential direction of the first insulating sheet, and the second insulating portion of the first insulating sheet is a portion of the first insulating sheet that is folded along the cut so as to pass through the space between the first terminal portion and the second terminal portion.

In the second aspect, part of the first insulating sheet is folded along the cut and passed through the space between the first terminal portion and the second terminal portion. Therefore, short-circuiting between the first terminal portion and the second terminal portion can be reduced.

According to a third aspect, in the welding transformer of the second aspect, the insulating sheet includes a second insulating sheet having a substantially rectangular shape, the first insulating portion of the second insulating sheet is a portion that extends along an upper surface of the body portion of an uppermost layer out of the plurality of unit coil components stacked on top of each other, and the second insulating portion of the second insulating sheet is a portion that passes through the space between the first terminal portion and the second terminal portion and extends along a lower surface of the body portion of a lowermost layer.

In the third aspect, part of the second insulating sheet is folded and passed through the spaces between the first terminal portion and the second terminal portion of the unit coil components of the uppermost to lowermost layers. Therefore, short-circuiting between the first terminal portion and the second terminal portion can be reduced.

According to the aspects of the present disclosure, short-circuiting between the first terminal portion and the second terminal portion of the unit coil can be reduced.

### BRIEF DESCRIPTION OF THE DRAWINGS

FIG. 1 is a perspective view of a welding transformer according to an embodiment as viewed from primary-side external terminals.

FIG. 2 is a perspective view of the welding transformer as viewed from secondary-side external terminals.

FIG. 3 is an exploded perspective view of a main part of the welding transformer.

FIG. 4 is an exploded perspective view of a magnetic core.

FIG. 5 is a plan view of a first unit coil.

FIG. 6 is a plan view of a second unit coil.

FIG. 7 is a side sectional view of a primary-side unit coil as viewed from the terminal side.

FIG. 8 is a plan view of a secondary-side unit coil.

FIG. 9 is a side sectional view of the secondary-side unit coil as viewed from the terminal side.

FIG. 10 is a plan view illustrating a state in which a first insulating sheet is placed on a copper plate of the first layer.

FIG. 11 is a plan view illustrating a state in which a copper plate of the second layer is placed on the copper plate of the first layer.

FIG. 12 is a sectional view taken along arrows A-A in FIG. 11.

FIG. 13 is a plan view illustrating a state in which a first insulating sheet is placed on the copper plate of the second layer.

FIG. 14 is a sectional view taken along arrows B-B in FIG. 13.

FIG. 15 is a plan view illustrating a state in which a copper plate of the third layer is placed on the copper plate of the second layer.

FIG. 16 is a sectional view taken along arrows C-C in FIG. 15.

FIG. 17 is a plan view illustrating a state in which a second insulating sheet is placed on the copper plate of the third layer.

FIG. 18 is a sectional view taken along arrows D-D in FIG. 17.

FIG. 19 is a plan view illustrating a state in which the first unit coil is placed on a third insulating sheet.

FIG. 20 is a sectional view taken along arrows E-E in FIG. 19.

FIG. 21 is a plan view showing a state in which first flap portions are folded back.

FIG. 22 is a plan view showing a state in which a right second flap portion and a right third flap portion are folded back.

FIG. 23 is a plan view showing a state in which a left second flap portion and a left third flap portion are folded back.

FIG. 24 is a plan view showing a state in which a fourth flap portion is folded back.

### DETAILED DESCRIPTION

Hereinafter, an embodiment of the present invention will be described with reference to the drawings. It should be noted that the following description of the preferred embodiment is merely illustrative in nature, and is not intended to limit the present invention, its applications, or its uses.

### Configuration of Welding Transformer

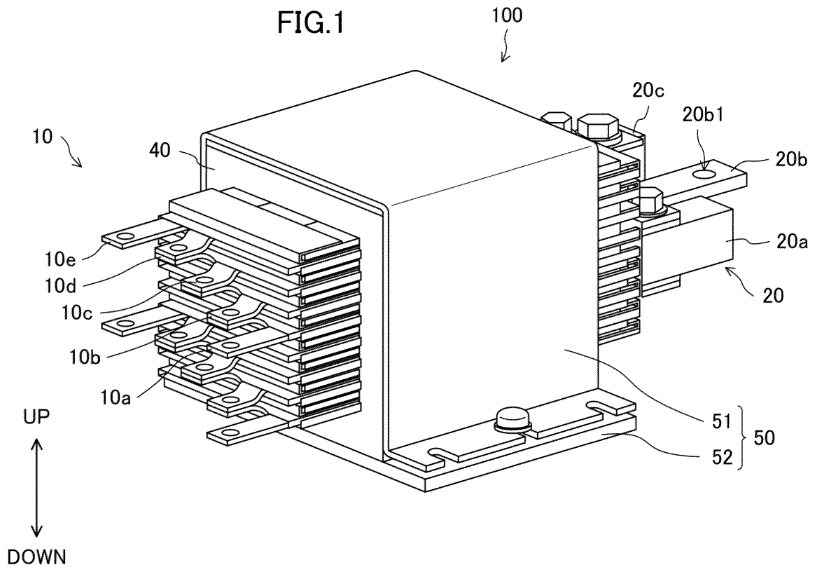

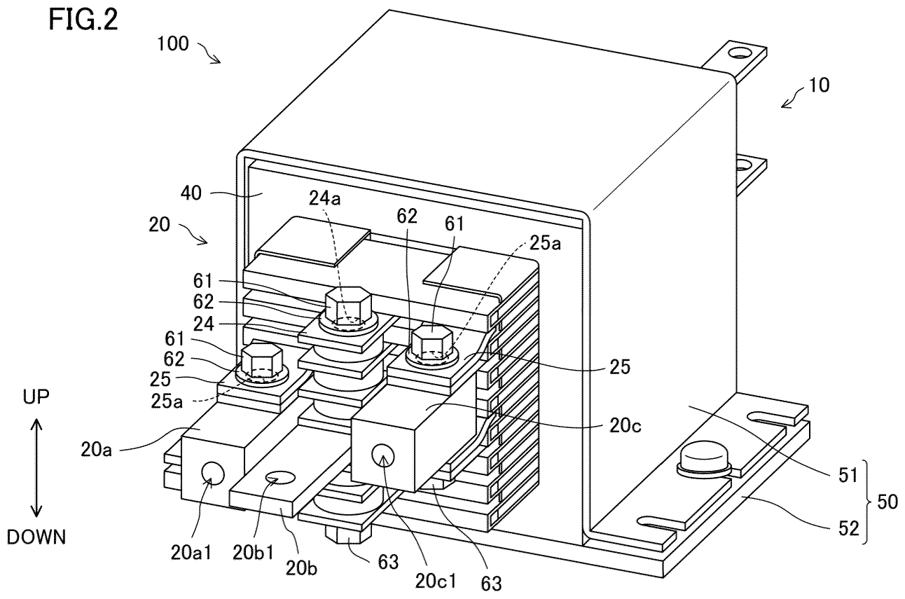

As shown in FIGS. 1 and 2, a welding transformer 100 includes a primary-side coil 10, a secondary-side coil 20, a magnetic core 40, and a fixture 50. For example, the welding transformer 100 is used as a voltage converter unit for a welding inverter power supply (not shown).

In the following description, the side on which a holding plate 51 of the fixture 50 shown in FIG. 1 is provided is sometimes referred to as upper or upper side. The opposite side, namely the side on which a support plate 52 is provided, is sometimes referred to as lower or lower side.

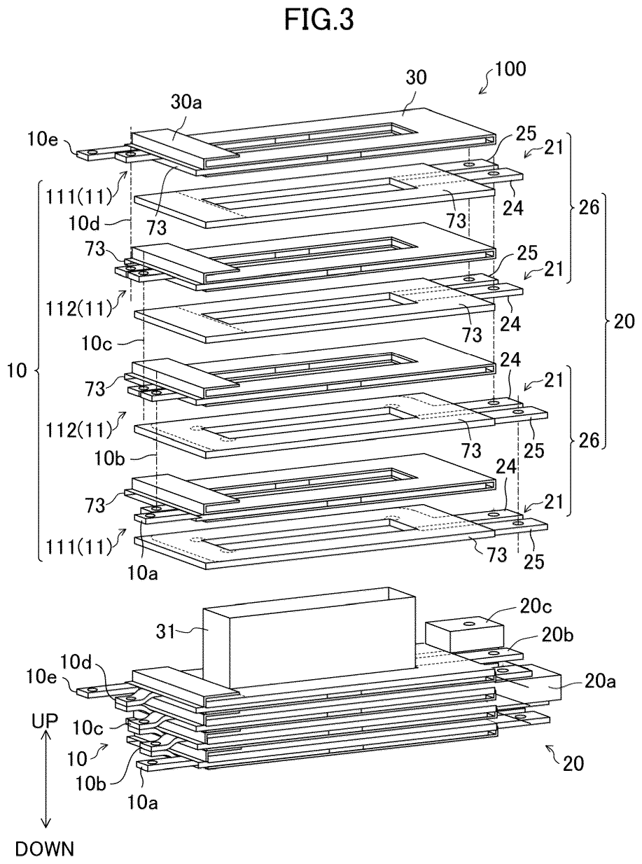

As shown in FIGS. 1 and 3, the primary-side coil 10 is configured as unit circuits each composed of four primary-side unit coils 11 connected in series with each other. The unit circuit has five external terminals. In the example shown in FIG. 1, the primary-side coil 10 includes two unit circuits. However, the number of unit circuits included in the primary-side coil 10 is not particularly limited to this. The number of unit circuits included in the primary-side coil 10 may be one, or may be three or more, and may be changed as appropriate according to the specifications required for the welding transformer 100. The primary-side unit coil 11 is a one-turn coil made of a copper plate. This will be described in detail later. The manner in which the four primary unit coils 11 are connected will also be described later.

The primary-side coil 10 is a so-called high voltage-side coil to be connected to an external power supply, for example, an external commercial power supply. The number of turns of the primary-side coil 10 in the unit circuit is changed by changing the combination of two terminals to be connected to the external power supply out of five primary-side external terminals 10a to 10e.

For example, when the primary-side external terminal 10a and the primary-side external terminal 10e are connected to the external power supply, the number of turns of the primary-side coil 10 in the unit circuit is four turns. On the other hand, when the primary-side external terminal 10a and the primary-side external terminal 10b are connected to the external power supply, the number of turns of the primary-side coil 10 in the unit circuit is one turn.

The combination of the two terminals to be connected to the external power supply and therefore the number of turns of the primary-side coil 10 in the unit circuit can be changed according to the specifications required for the welding transformer 100.

The secondary-side coil 20 is configured as unit circuits each composed of four secondary-side unit coils 21. The unit circuit has three secondary-side external terminals 20a to 20c. The secondary-side external terminals 20a to 20c have external connection holes 20a1 to 20c1, respectively, to which wires for connection with other circuits are to be connected.

The number of unit circuits included in the secondary-side coil 20 is basically the same as the number of unit circuits included in the primary-side coil 10. Like the primary-side unit coil 11, the secondary-side unit coil 21 is also a one-turn coil made of a copper plate. This will be described later. The manner in which the four secondary-side unit coils 21 are connected will also be described later.

The secondary-side coil 20 is a so-called low voltage-side coil to be connected to internal bus bar wires (not shown) or internal circuit (not shown) such as a semiconductor power converter of an inverter power supply.

The number of turns of the secondary-side coil 20 in the unit circuit is changed by changing the combination of two terminals to be connected to the output side, namely the internal bus bar wires or internal circuit of the inverter power supply, out of the secondary-side external terminals 20a to 20c.

For example, when the secondary-side external terminal 20a and the secondary-side external terminal 20c are connected to the output side, the number of turns of the secondary-side coil 20 in the unit circuit is four turns. On the other hand, when the secondary-side external terminal 20a and the secondary-side external terminal 20b are connected to the output side, the number of turns of the secondary-side coil 20 in the unit circuit is two turns.

Similarly, when the secondary-side external terminal 20c and the secondary-side external terminal 20b are connected to the output side, the number of turns of the secondary-side coil 20 in the unit circuit is two turns. That is, the secondary-side external terminal 20b is an intermediate tap terminal. The combination of the two terminals to be connected to the output side and therefore the number of turns of the secondary-side coil 20 in the unit circuit can be changed according to the specifications required for the welding transformer 100.

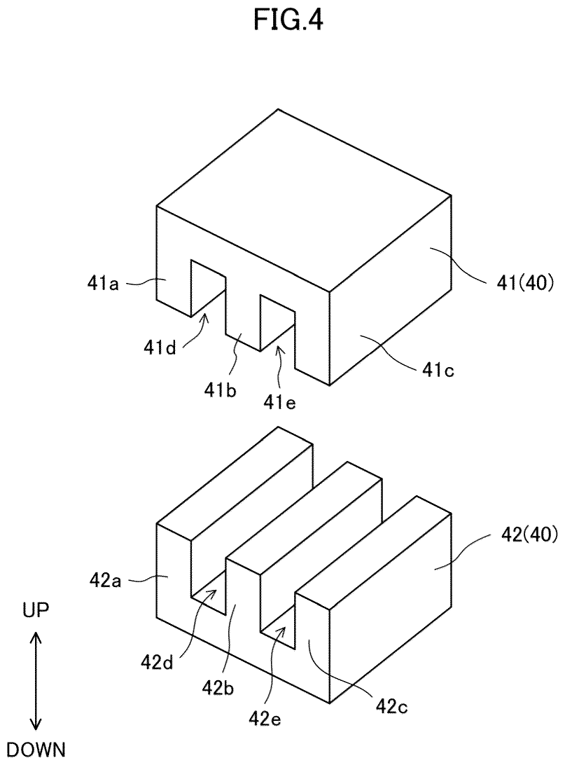

As shown in FIG. 4, the magnetic core 40 is a combination of two E-shaped cores 41, 42. In practical applications, four magnetic cores 40 are arranged side by side. However, the number of magnetic cores 40 to be used is not particularly limited to this, and may be changed as appropriate according to the size of the welding transformer 100, in particular, the sizes of the primary-side coil 10 and the secondary-side coil 20.

The E-shaped core 41 is made of a magnetic material such as ferrite and has three protrusions 41a to 41c and grooves 41d, 41e provided therebetween. The E-shaped core 42 is made of a magnetic material such as ferrite and has three protrusions 42a to 42c and grooves 42d, 42e provided therebetween. The protrusions 41b, 42b are disposed inside the primary-side coil 10 and the secondary-side coil 20. Two opposing sides of body portions 12, 22 (see FIGS. 3, 5, 6, and 8) of the primary-side coil 10 and the secondary-side coil 20 are accommodated in the grooves 41d, 42d and the grooves 41e, 42e.

Although the magnetic core 40 is not shown in FIG. 3, a tubular insulating sheet 31 is disposed inside the primary-side coil 10 and the secondary-side coil 20 so as to extend along the inner peripheral surfaces of the primary-side coil 10 and the secondary-side coil 20. This ensures insulation between the magnetic core 40 and the primary-side coil 10 and secondary-side coil 20.

As shown in FIGS. 1 and 2, the fixture 50 has the holding plate 51 and the support plate 52. The stack of the primary-side coil 10 and the secondary-side coil 20 with the magnetic core 40 mounted thereon is placed on the support plate 52, the stack is then held down from above by the holding plate 51, and the holding plate 51 is connected to the support plate 52 by a method such as screwing. The stack of the primary-side coil 10 and the secondary-side coil 20 with the magnetic core 40 mounted thereon is held and fixed in this manner.

### Configurations of Primary-Side and Secondary-Side Unit Coils

As shown in FIG. 3, the primary-side unit coils 11 include first unit coils 111 and second unit coils 112. As shown in FIG. 7 that is a side sectional view of the primary-side unit coil 11 as viewed from the terminal side, the first unit coil 111 is composed of a set of a plurality of copper plates 11a (unit coil components) having the same shape. In the example shown in FIG. 7, three copper plates 11a are stacked. Each of the copper plates 11a has a thickness of about 0.4 mm to 1.0 mm.

First insulating sheets 71 and a second insulating sheet 72 are sandwiched between the three stacked copper plates 11a. The stack of the three copper plates 11a, the two insulating sheets 71, and the one second insulating sheet 71 shown in FIG. 7 is wrapped in a third insulating sheet 73. One first unit coil 111 shown in FIG. 3 is thus formed. How the first insulating sheets 71 and the second insulating sheet 72 are sandwiched between the copper plates 11a will be described later.

As shown in FIG. 9, the second unit coil 112 is also composed of a set of a plurality of (e.g., two) copper plates 21a having the same shape. Each of the copper plates 21a has a thickness similar to that of the copper plates 11a of the first unit coil 111.

A first insulating sheet 71 and a second insulating sheet 72 are sandwiched between the two stacked copper plates, and the stack thus obtained is then wrapped in a third insulating sheet 73. Each second unit coil 112 shown in FIG. 3 is thus formed.

The numbers of copper plates included in the first unit coil 111 and the second unit coil 112 are not particularly limited to the example shown in FIG. 9, and may be changed as appropriate according to the electrical resistance allowed for the primary-side coil 10, the number of turns of the primary-side coil 10, etc.

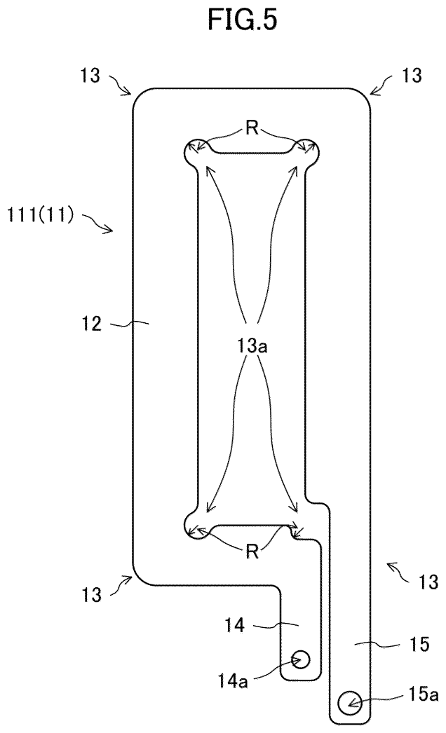

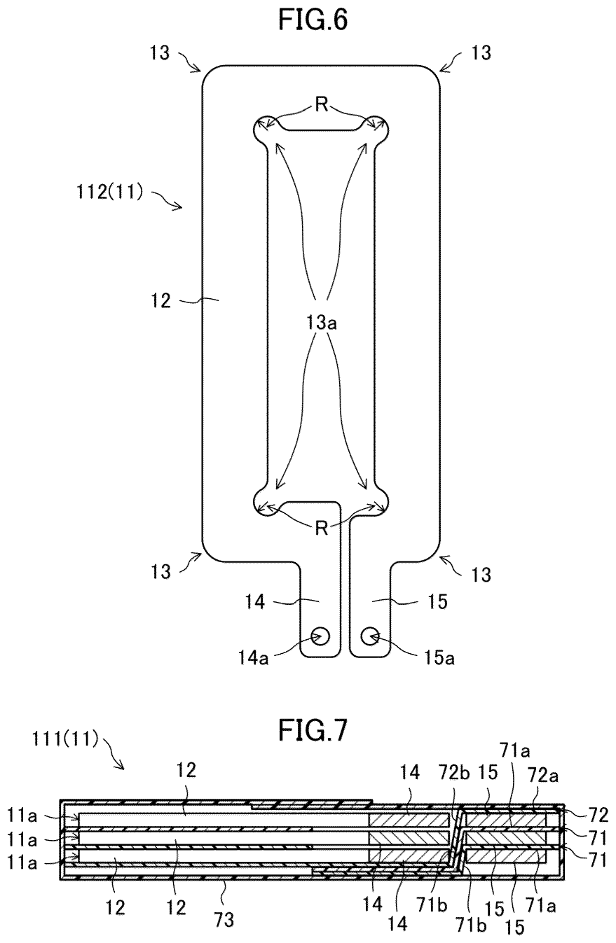

For example, the first unit coil 111 and the second unit coil 112 are obtained by punching a copper plate. The first unit coil 111 and the second unit coil 112 may alternatively be formed by bending a rectangular copper wire in the edge-wise direction (width direction). In this case, recesses 13a of corner portions 13, a terminal hole 14a of a first terminal portion 14, and a terminal hole 15a of a second terminal portion 15, which will be described later, are formed by different processing (see FIGS. 5 and 6).

As shown in FIGS. 5 and 6, each of the first unit coil 111 and the second unit coil 112 has the body portion 12, the first terminal portion 14, and the second terminal portion 15.

The body portion 12 has a substantially quadrangular annular shape and has four corner portions 13. The recesses 13a that are recessed toward the outer periphery are formed in the inner peripheral surfaces of the four corner portions 13. The recesses 13a have a substantially circular outer shape as viewed in plan, and the recesses 13a are formed so that the recesses 13a in the four corner portions 13 have the same radius of curvature R. In other words, the recesses 13a are formed such that the body portion 12 is removed by the same distance R from the inner vertices that the corner portions 13 have when the recesses 13a are not formed.

The recesses 13a are formed so that their radius of curvature R is the same between the first unit coil 111 and the second unit coil 112. The outer shape and size of the body portion 12 are set to be the same between the first unit coil 111 and the second unit coil 112.

The first terminal portion 14 and the second terminal portion 15 are extended from both ends of the body portion 12, located side by side and spaced apart from each other, and extend in the same direction.

As shown in FIGS. 5 and 6, the positions of the first terminal portion 14 and the second terminal portion 15 are different between the first unit coil 111 and the second unit coil 112.

As shown in FIG. 5, the second terminal portion 15 of the first unit coil 111 is an extension from the end of one side of the body portion 12. The first terminal portion 14 is a portion extending from the end of another side of the body portion 12 that extends in a direction crossing the second terminal portion 15, and located next to and spaced apart from the second terminal portion 15.

As shown in FIG. 6, on the other hand, in the second unit coil 112, both ends of the body portion 12 are provided spaced apart from each other in one side of the body portion 12 that extends in a direction crossing the direction in which the first terminal portion 14 and the second terminal portion 15 extend. The first terminal portion 14 and the second terminal portion 15 extend side by side from one end and the other end of the body portion 12, respectively.

When the first unit coil 111 and the second unit coil 112 are stacked such that their body portions 12 are located exactly on top of each other, the first terminal portion 14 of the first unit coil 111 is positioned exactly on top of the second terminal portion 15 of the second unit coil 112 as viewed in plan. More specifically, the positions of the first terminal portion 14 (see FIG. 5) of the first unit coil 111 and the second terminal portion 15 (see FIG. 6) of the second unit coil 112 are set so that the terminal hole 14a (see FIG. 5) provided in the first terminal portion 14 of the first unit coil 111 is aligned with the terminal hole 15a (see FIG. 6) provided in the second terminal portion 15 of the second unit coil 112.

When two second unit coils 112 are stacked reversed with respect to each other (stacked front-to-front or back-to-back) such that their body portions 12 are located exactly on top of each other, the first terminal portion 14 of one second unit coil 112 is positioned exactly on top of the first terminal portion 14 of the other second unit coil 112 as viewed in plan. More specifically, the position of the first terminal portion 14 of the second unit coil 112 is set so that the terminal hole 14a provided in the first terminal portion 14 of one second unit coil 112 is aligned with the terminal hole 14a provided in the first terminal portion 14 of the other second unit coil 112.

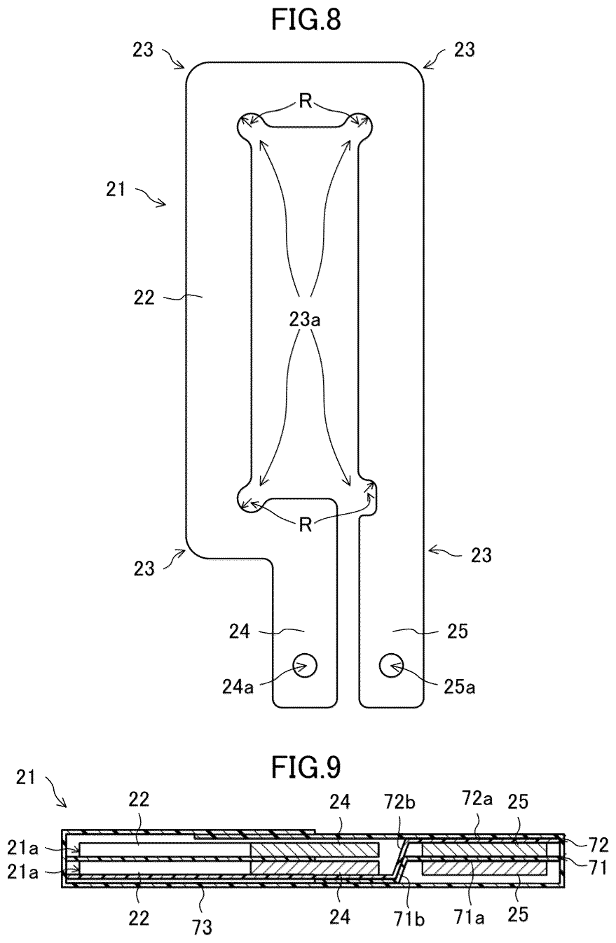

Like the first unit coil 111 (see FIG. 5) and the second unit coil 112 (see FIG. 6), the secondary-side unit coil 21 shown in FIGS. 8 and 9 is composed of a set of a plurality of (e.g., two) copper plates 21a having the same shape. Each of the copper plates 21a has a thickness of about 0.4 mm to 1.0 mm.

A first insulating sheet 71 and a second insulating sheet 72 are sandwiched between the two stacked copper plates 21a. The stack of the two copper plates 21a, the first insulating sheet 71, and the second insulating sheet 72 shown in FIG. 9 is then wrapped in a third insulating sheet 73. Each secondary-side unit coil 21 shown in FIG. 3 is thus formed.

The number of copper plates 21a included in the secondary-side unit coil 21 is not particularly limited to the example shown in FIG. 9, and may be changed as appropriate according to the electrical resistance allowed for the secondary-side coil 20, the number of turns of the secondary-side coil 20, etc. The secondary-side unit coil 21 is manufactured by a method similar to the method for the first unit coil 111 and the second unit coil 112 described above.

The secondary-side unit coil 21 shown in FIG. 3 is composed of a stack of two coils having the planar shape shown in FIG. 8. However, the secondary-side unit coil 21 is not particularly limited to this, and may be changed as appropriate according to the electrical resistance or current range allowed for the secondary-side coil 20. For example, the secondary-side unit coil 21 may be composed of only one coil having the planar shape shown in FIG. 8.

It should be understood that this also applies to the primary-side unit coil 11. For example, the first unit coil 111 may be composed of a stack of two coils having the planar shape shown in FIG. 5. The second unit coil 112 may be composed of a stack of two coils having the planar shape shown in FIG. 6.

As shown in FIG. 8, like the first unit coil 111 (see FIG. 5) and the second unit coil 112 (see FIG. 6), the secondary-side unit coil 21 has a body portion 22, a first terminal portion 24, and a second terminal portion 25.

The secondary-side unit coil 21 is also the same as the first unit coil 111 and the second unit coil 112 in the shape of the body portion 22 and in that recesses 23a are provided in the inner peripheral surfaces of four corners 23. The secondary-side unit coil 21 is also the same as the first unit coil 111 and the second unit coil 112 in that the recesses 23a are formed so that the recesses 23a in the four corner portions 23 have the same radius of curvature R, namely such that the body portion 22 is removed by the same distance R from the inner vertices that the corner portions 23 have when the recesses 23a are not formed.

The recesses 23a of the secondary-side unit coil 21 are formed so as to have the same radius of curvature R as the radius of curvature R of the recesses 13a of the first unit coil 111 and the second unit coil 112. In the secondary-side unit coil 21, the outer shape and size of the body portion 22 are set to be substantially the same as those of the first unit coil 111 and the second unit coil 112.

The first terminal portion 24 and the second terminal portion 25 are extended from both ends of the body portion 22 and extend side by side in the same direction.

As shown in FIG. 8, the second terminal portion 25 of the secondary-side unit coil 21 is an extension from the end of one side of the body portion 22. The first terminal portion 24 extends from the end of another side of the body portion 22 that extends in a direction crossing the second terminal portion 25, and is located next to and spaced apart from the second terminal portion 25.

When two secondary-side unit coils 21 are stacked reversed with respect to each other (stacked front-to-front or back-to-back) such that their body portions 22 are located exactly on top of each other, the first terminal portion 24 of one secondary-side unit coil 21 is positioned exactly on top of the first terminal portion 24 of the other secondary-side unit coil 21 as viewed in plan. More specifically, the position of the first terminal portion 24 of the secondary-side unit coil 21 is set so that a terminal hole 24a provided in the first terminal portion 24 of one secondary-side unit coil 21 is aligned with a terminal hole 24a provided in the first terminal portion 24 of the other secondary-side unit coil 21.

### Configuration of Primary-Side Unit Coil

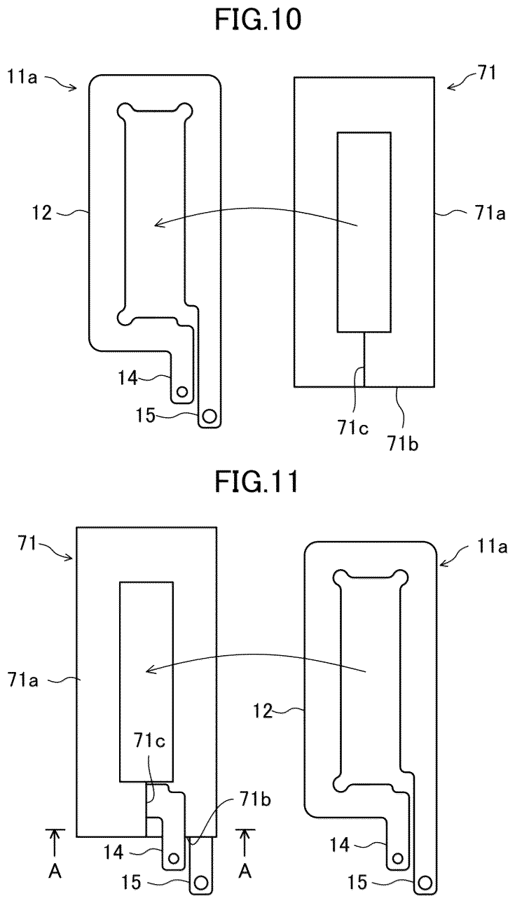

As shown in FIG. 7 that is a side sectional view of the primary-side unit coil 11 as viewed from the terminal side, the primary-side unit coil 11 is composed of a stack of a plurality of (e.g., three) copper plates 11a as unit coil components that are plate-like conductors. The copper plate 11a has the body portion 12 extending in an annular shape, and the first terminal portion 14 and the second terminal portion 15 that are extended from the body portion 12 and that extend in the same direction and spaced apart from each other (see also FIG. 10). The plurality of copper plates 11a is insulated from each other by the first insulating sheets 71 and the second insulating sheet 72. The stack of the plurality of copper plates 11a, the first insulating sheets 71, and the second insulating sheet 72 is covered by the third insulating sheet 73.

A procedure for assembling the primary-side unit coil 11 will now be described. As shown in FIG. 10, a first insulating sheet 71 of the first layer is stacked on the upper surface of a copper plate 11a of the first layer. The first insulating sheet 71 is formed in an annular shape along the body portion 12 of the copper plate 11a. The first insulating sheet 71 has a cut 71c made in its portion in the circumferential direction.

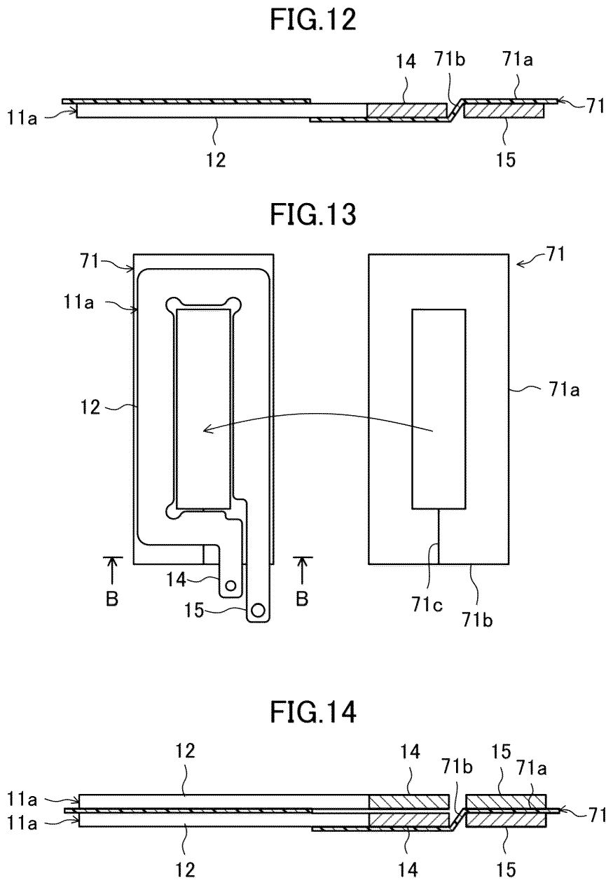

As shown also in FIG. 11 and FIG. 12 that is a sectional view taken along arrows A-A in FIG. 11, the first insulating sheet 71 has a first insulating portion 71a that extends along the surface of the body portion 12, and a second insulating portion 71b that passes through the space between the first terminal portion 14 and the second terminal portion 15. The second insulating portion 71b is a portion of the first insulating sheet 71 that is folded along the cut 71c so as to pass through the space between the first terminal portion 14 and the second terminal portion 15.

As shown in FIG. 12, a portion of the first insulating sheet 71 is folded along the cut 71c and is passed through the space between the first terminal portion 14 and the second terminal portion 15. This can reduce short-circuiting between the first terminal portion 14 and the second terminal portion 15.

In the state shown in FIG. 11, a copper plate 11a of the second layer is placed on the upper surfaces of the copper plate 11a of the first layer and the first insulating sheet 71 of the first layer. The state shown in FIG. 13 and FIG. 14 that is a sectional view taken along arrows B-B in FIG. 13 is thus obtained. As shown in FIG. 14, the copper plate 11a of the first layer and the copper plate 11a of the second layer are insulated from each other by the first insulating sheet 71.

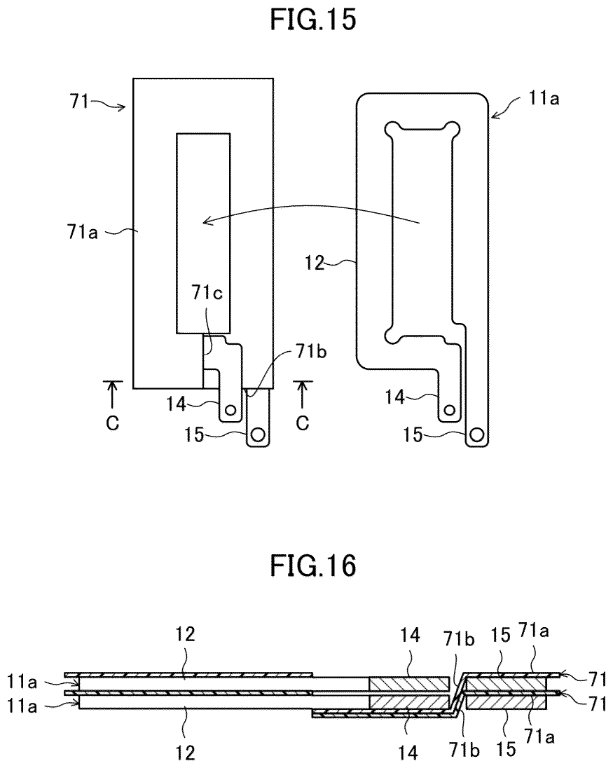

In the state shown in FIG. 13, a first insulating sheet 71 of the second layer is placed on the upper surface of the second copper plate 11a. The state shown in FIG. 15 and FIG. 16 that is a sectional view taken along arrows C-C in FIG. 15 is thus obtained. As shown in FIG. 16, a second insulating portion 71b of the first insulating sheet 71 of the second layer is inserted so as to pass through the space between the first terminal portion 14 and the second terminal portion 15 of the copper plate 11a of the first layer and the space between the first terminal portion 14 and the second terminal portion 15 of the copper plate 11a of the second layer.

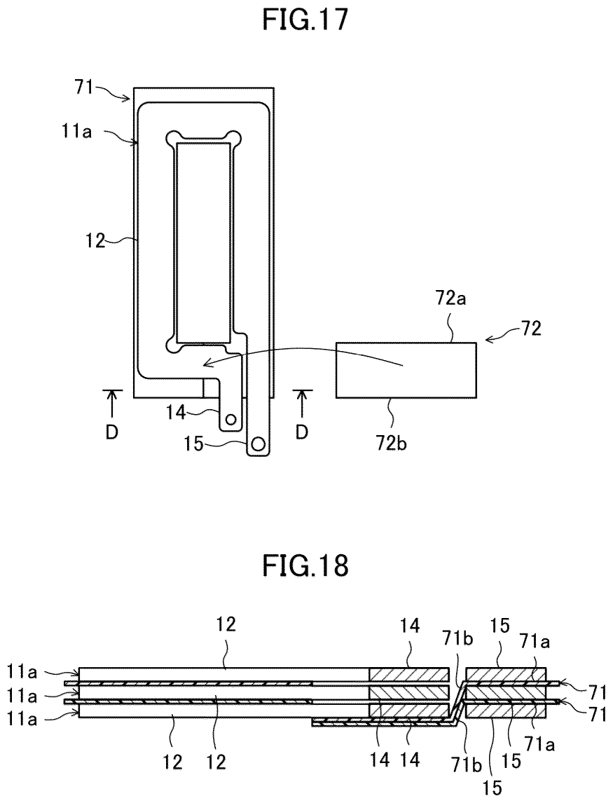

In the state shown in FIG. 15, a copper plate 11a of the third layer is placed on the upper surfaces of the copper plate 11a of the second layer and the first insulating sheet 71 of the second layer. The state shown in FIG. 17 and FIG. 18 that is a sectional view taken along arrows D-D in FIG. 17 is thus obtained. As shown in FIG. 18, the copper plate 11a of the second layer and the copper plate 11a of the third layer are insulated from each other by the first insulating sheet 71 of the second layer.

As shown in FIG. 17, a second insulating sheet 72 is placed on the upper surface of the copper plate 11a of the third layer. The second insulating sheet 72 is formed in a substantially rectangular shape. The second insulating sheet 72 includes a first insulating portion 72a that extends along the surface of the body portion 12, and a second insulating portion 72b that passes through the spaces between the first terminal portion 14 and the second terminal portion 15 (see FIGS. 17 and 20).

The first insulating portion 72a of the second insulating sheet 72 is a portion that extends along the upper surface of the body portion 12 of the uppermost layer out of the plurality of stacked copper plates 11a (see FIG. 20). The second insulating portion 72b of the second insulating sheet 72 is a portion that passes through the spaces between the first terminal portion 14 and the second terminal portion 15 and extends along the lower surface of the body portion 12 of the lowermost layer (see FIG. 20).

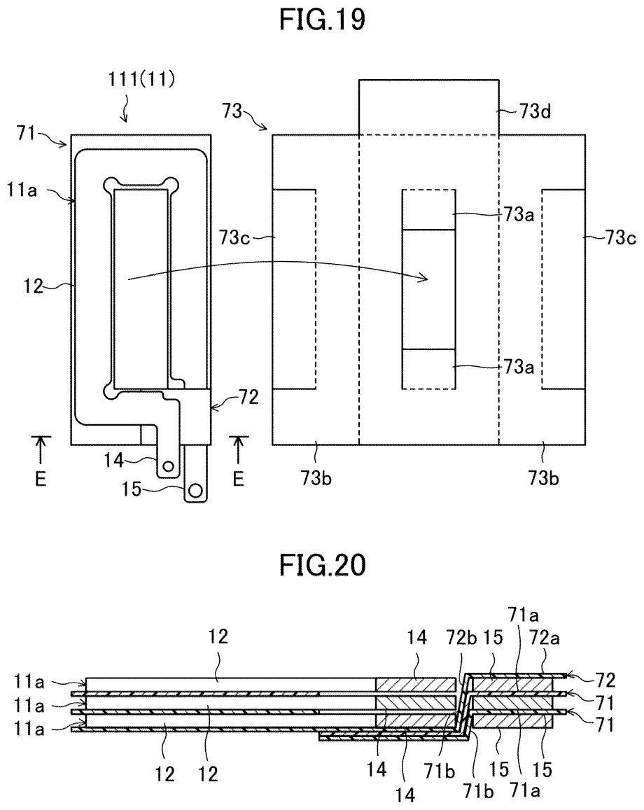

The state shown in FIGS. 19 and 20 is obtained by placing the second insulating sheet 72 on the upper surface of the copper plate 11a of the third layer (uppermost layer) in the state shown in FIG. 17. As shown in FIG. 20, the first insulating portion 72a of the second insulating sheet 72 is disposed along the upper surface of the body portion 12 of the copper plate 11a of the third layer. The second insulating portion 72b of the second insulating sheet 72 is passed through the spaces between the first terminal portion 14 and the second terminal portion 15 of the copper plates 11a of the first layer (lowermost layer), the second layer, and the third layer (uppermost layer), and is then disposed along the lower surface of the copper plate 11a of the first layer (lowermost layer).

As shown in FIG. 19, the primary-side unit coil 11 that is a stack of the three copper plates 11a, the two first insulating sheets 71, and the one second insulating sheet 72 (see FIG. 18) is placed on the third insulating sheet 73.

The third insulating sheet 73 is formed by making a plurality of cuts in a sheet of insulating paper. The number of cuts and their positions and lengths are according to the shape of the primary-side unit coil 11, and the third insulating sheet 73 is folded at the cuts to wrap the primary-side unit coil 11.

The third insulating sheet 73 includes first flap portions 73a, second flap portions 73b, third flap portions 73c, and a fourth flap portion 73d.

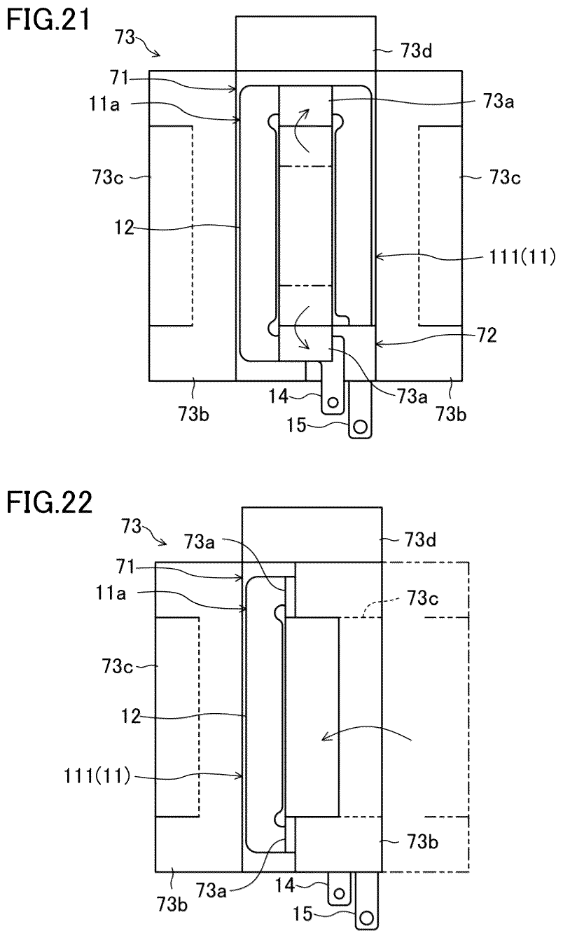

As shown in FIG. 21, after the primary-side unit coil 11 is placed on the third insulating sheet 73, the first flap portions 73a are folded back through a central opening of the body portion 12 of the primary-side unit coil 11 and central openings of the first insulating sheets 71.

As shown in FIG. 22, the right second flap portion 73b is folded back to cover the right half of the primary-side unit coil 11, and the third flap portion 73c is then folded back through the central opening of the body portion 12 of the primary-side unit coil 11 and the central openings of the first insulating sheets 71.

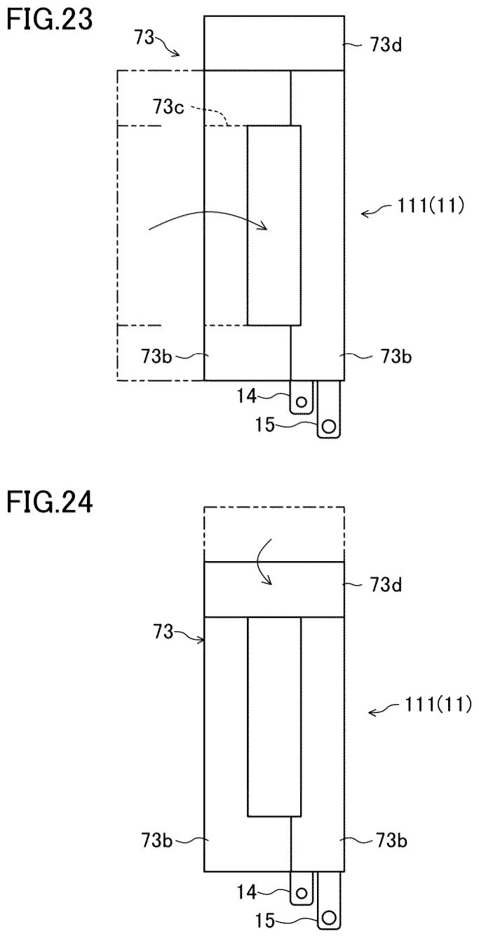

As shown in FIG. 23, the left second flap portion 73b is folded back to cover the left half of the primary-side unit coil 11, and the third flap portion 73c is then folded back through the central opening of the body portion 12 of the primary-side unit coil 11 and the central openings of the first insulating sheets 71.

As shown in FIG. 24, the fourth flap portion 73d is folded back. The surfaces of the primary-side unit coil 11 can thus be completely covered except for the first terminal portion 14 and the second terminal portion 15 of the primary-side unit coil 11.

Since the secondary-side unit coil 21 can be assembled in a procedure similar to that of the primary-side unit coil 11, description thereof will be omitted.

### Configurations of Primary-Side and Secondary-Side Coils

As shown in FIG. 3, the primary-side unit coils 11 and the secondary-side unit coils 21 are alternately stacked such that the primary-side unit coils 11 and the secondary-side unit coils 21 are insulated from each other by the insulating sheets 30. The insulating sheet 30 that covers the primary-side unit coil 11 has a folded-back portion 30a, and part of the secondary-side unit coil 21 covered by the insulating sheet 73 is wrapped in the folded-back portion 30a. However, the folded-back portion 30a need not necessarily be provided, and may be omitted.

The primary-side coil 10 and the secondary-side coil 20 are alternately arranged in order of the primary-side coil 10 and the secondary-side coil 20 from top to bottom.

The first unit coils 111 and the second unit coils 112 that constitute the primary-side coil 10 are arranged as follows.

As the primary-side coil 10, the first unit coils 111 are placed at the first and fourth positions from the top, and the second unit coils 112 are placed at the second and third positions from the top. The first unit coil 111 placed at the fourth position is reversed with respect to the first unit coil 111 placed at the first position such that the positions of their terminal portions become symmetrical in their lateral direction. The second unit coil 112 placed at the third position is reversed with respect to the second unit coil 112 placed at the second position such that the positions of their terminal portions become symmetrical in their lateral direction.

Since the first unit coils 111 and the second unit coils 112 are arranged in this manner, the first terminal portion 14 of the first unit coil 111 placed at the fourth position and the second terminal portion 15 of the second unit coil 112 placed at the third position can be positioned exactly on top of each other as viewed from above, and the terminal holes 14a, 15a provided in the first and second terminal portions 14, 15, respectively, can be aligned with each other. The primary-side external terminal 10b (see FIGS. 1, 3) can be formed by passing a screw etc., not shown, through the two terminal holes 14a, 15a and tightening it.

Similarly, the first terminal portion 14 of the second unit coil 112 placed at the third position and the first terminal portion 14 of the second unit coil 112 placed at the second position can be positioned exactly on top of each other as viewed from above, so that the primary-side external terminal 10c (see FIGS. 1, 3) can be formed. The second terminal portion 15 of the second unit coil 112 placed at the second position and the first terminal portion 14 of the first unit coil 111 placed at the first position can be positioned exactly on top of each other as viewed from above, so that the primary-side external terminal 10d (see FIGS. 1, 3) can be formed. The second terminal portion 15 of the first unit coil 111 placed at the fourth position is the primary-side external terminal 10a, and the second terminal portion 15 of the first unit coil 111 placed at the first position is the primary-side external terminal 10e.

In this manner, the structure in which the four primary-side unit coils 11 are connected in series can be easily formed using only two types of unit coils, the first unit coils 111 and the second unit coils 112.

The secondary-side unit coils 21 (see FIGS. 3, 8, and 9) that constitute the secondary-side coil 20 (see FIGS. 1, 2, and 3) are arranged as follows.

As the secondary-side coil 20, the secondary-side unit coils 21 placed at the first and second positions from the top are arranged such that both of them face the same direction. The secondary-side unit coils 21 placed at the third and fourth positions from the top are arranged such that both of them face the same direction. On the other hand, the second-side unit coils 21 placed at the second and third positions are reversed with respect to each other. In other words, the secondary-side unit coils 21 placed at the third and fourth positions are reversed with respect to the secondary-side unit coils 21 placed at the first and second positions.

Since the four secondary-side unit coils 21 are arranged in this manner, the second terminal portion 25 of the secondary-side unit coil 21 placed at the fourth position and the second terminal portion 25 of the secondary-side unit coil 21 placed at the third position can be positioned exactly on top of each other as viewed from above, and terminal holes 25a provided in these second terminal portions 25 can be aligned with each other. As shown in FIG. 2, the second terminal portions 25 of the secondary-side unit coils 21 placed at the third and fourth positions and the secondary-side external terminal 20a can be connected by passing a bolt 61 through the two terminal holes 25a and a through hole (not shown) provided in the secondary-side external terminal 20a and tightening it.

Similarly, the first terminal portion 24 of the secondary-side unit coil 21 placed at the fourth position and the first terminal portion 24 of the secondary-side unit coil 21 placed at the third position can be positioned exactly on top of each other as viewed from above, and the first terminal portions 24 of the secondary-side unit coils 21 placed at the third and fourth positions and the secondary-side external terminal 20b can be connected using a bolt 61, a washer 62, and a nut 63. A parallel connection structure 26 (see FIG. 3) in which the secondary-side unit coil 21 placed at the third position and the secondary-side unit coil 21 placed at the fourth position are connected in parallel is configured in this manner.

The first terminal portions 24 of the secondary-side unit coils 21 placed at the second and first positions can be positioned exactly on top of the first terminal portions 24 of the secondary-side unit coils 21 placed at the third and fourth positions as viewed from above, and the terminal holes 24a provided in these first terminal portions 24 can be aligned with each other. Therefore, as shown in FIG. 2, the first terminal portions 24 of the secondary-side unit coils 21 placed at the first to fourth positions and the secondary-side external terminal 20b can be connected using the bolt 61, the washer 62, and the nut 63.

The second terminal portion 25 of the secondary-side unit coil 21 placed at the second position and the second terminal portion 25 of the secondary-side unit coil 21 placed at the first position can be positioned exactly on top of each other as viewed from above, and terminal holes 25a provided in these second terminal portions 25 can be aligned with each other. As shown in FIG. 2, the terminal holes 25a of the second terminal portions 25 of the secondary-side unit coils 21 placed at the first and second positions and the secondary-side external terminal 20c can be connected by passing a bolt 61 through the two terminal holes 25a and a through hole (not shown) provided in the secondary-side external terminal 20c and tightening it.

A parallel connection structure 26 (see FIG. 3) in which the secondary-side unit coil 21 placed at the first position and the secondary-side unit coil 21 placed at the second position are connected in parallel is configured in this manner. The two parallel connection structures 26 are connected in series.

### Effects of Embodiment

As described above, according to the welding transformer 100 of the present embodiment, the body portions 12 of the stacked copper plates 11a can be insulated from each other by the first insulating portions 71a of the first insulating sheets 71, and the first terminal portion 14 and the second terminal portion 15 can be insulated from each other by the second insulating portion 71b of the first insulating sheet 71. Since part of the first insulating sheet 71 is passed between the first terminal portion 14 and the second terminal portion 15 as described above, short-circuiting between the first terminal portion 14 and the second terminal portion 15 can be reduced even when dust etc. is generated in the welding work environment.

Moreover, a substantial insulation distance can be increased inside the welding transformer 100. Specifically, when the second insulating portion 71b is not passed through the space between the first terminal portion 14 and the second terminal portion 15, the insulation distance is the space (e.g., 2 mm) between the first terminal portion 14 and the second terminal portion 15. On the other hand, when the second insulating portion 71b is passed through the space between the first terminal portion 14 and the second terminal portion 15, the insulation distance is the space (e.g., 8.5 mm) between the first terminal portion 14 and the second terminal portion 15 in the portion not covered by the second insulating sheet 72 shown in FIG. 19 near the recess 13a (see FIG. 5) in the lower right corner 13 of the primary-side unit coil 11.

Since part of the first insulating sheet 71 is folded along the cut 71c and passed through the space between the first terminal portion 14 and the second terminal portion 15, short-circuiting between the first terminal portion 14 and the second terminal portion 15 can be reduced.

Since part of the second insulating sheet 72 is folded and passed through the spaces between the first terminal portion 14 and the second terminal portion 15 of the copper plates 11a of the uppermost to lowermost layers, short-circuiting between the first terminal portion 14 and the second terminal portion 15 can be reduced.

### Other Embodiments

The above embodiment may be configured as follows.

The above embodiment illustrates an example in which the primary-side unit coils 11 of the primary-side coil 10 and the secondary-side unit coils 21 of the secondary-side coil 20 (see FIG. 3) are made of copper plates. However, a material other than copper may be used depending on the electrical resistance ranges allowed for the primary-side coil 10 and the secondary-side coil 20. That is, the primary-side unit coils 11 and the secondary-side unit coils 21 can be any plate-like conductors whose electrical resistances fall within their allowable ranges.

As described above, the present invention is practically advantageous in that it can reduce short-circuiting between terminals of coils. The present invention is therefore extremely useful and highly industrially applicable.

What is claimed is:

1. A welding transformer comprising a coil including a plurality of unit coils, wherein
the unit coil is composed of a stack of a plurality of unit coil components that is plate-like conductors, and
the unit coil component includes a body portion that extends in an annular shape, and a first terminal portion and a second terminal portion that are extended from the body portion and that extend in the same direction and spaced apart from each other, the welding transformer further comprising:
an insulating sheet that insulates the unit coil component, wherein
the insulating sheet includes a first insulating portion that extends along a surface of the body portion, and a second insulating portion that passes through a space between the first terminal portion and the second terminal portion.

2. The welding transformer of claim 1, wherein
the insulating sheet includes a first insulating sheet having an annular shape along the body portion,
the first insulating sheet has a cut made in a portion in a circumferential direction of the first insulating sheet, and
the second insulating portion of the first insulating sheet is a portion of the first insulating sheet that is folded along the cut so as to pass through the space between the first terminal portion and the second terminal portion.

3. The welding transformer of claim 2, wherein
the insulating sheet includes a second insulating sheet having a substantially rectangular shape,
the first insulating portion of the second insulating sheet is a portion that extends along an upper surface of the body portion of an uppermost layer out of the plurality of unit coil components stacked on top of each other, and
the second insulating portion of the second insulating sheet is a portion that passes through the space between the first terminal portion and the second terminal portion and extends along a lower surface of the body portion of a lowermost layer.
